(19) United States
(12) Patent Application Publication
(10) Pub. No.: US 2018/0322836 A1
(43) Pub. Date: Nov. 8, 2018

(54) LIQUID CRYSTAL PIXEL CIRCUIT AND LIQUID CRYSTAL DISPLAY DEVICE

(71) Applicant: SHENZHEN CHINA STAR OPTOELECTRONICS TECHNOLOGY CO., LTD., Shenzhen, Guangdong (CN)

(72) Inventor: Liyang AN, Shenzhen (CN)

(73) Assignee: SHENZHEN CHINA STAR OPTOELECTRONICS TECHNOLOGY CO., LTD., Shenzhen, Guangdong (CN)

(21) Appl. No.: 15/524,832

(22) PCT Filed: Mar. 10, 2017
(86) PCT No.: PCT/CN2017/076309

§ 371 Date: May 5, 2017

(30) Foreign Application Priority Data
Feb. 9, 2017 (CN) 201710071175.5

(51) Int. Cl. G09G 3/36; G02F 1/1362; G02F 1/1368

(52) U.S. Cl. CPC G09G 3/3648; G02F 1/136286; G02F 1/1368; G02F 2201/121; G09G 2320/0242; G09G 3/3614; G09G 2320/0233

(57) ABSTRACT

A liquid crystal pixel circuit and a liquid crystal display device are provided. The liquid crystal pixel circuit has a plurality of pixels, and each of the pixels comprises a first pixel area, a second pixel area, and a capacitor coupling module; wherein when the scanning line is turned on, the first pixel area and the second pixel area are charged to a first potential value; and when a second one of the scanning lines is turned on, the first pixel area is charged to a second potential value and the second pixel area is charged to a third potential value.

### FIELD OF THE INVENTION

The present disclosure relates to a technical field of liquid crystal displays, and in particular to a liquid crystal pixel circuit and a liquid crystal display device.

### BACKGROUND OF THE INVENTION

With the rapid development of display technology, people of color liquid crystal display device displays have become increasingly demanding. The VA (Vertical Alignment) type liquid crystal display device has a high positive contrast. When viewed from the side, the VA type liquid crystal molecules are rotated in the vertical direction, resulting in a significant decrease in the contrast of the liquid crystal display device, and with a different view of the corner there will be a significant color shift.

The common method for solving low color cast phenomena is as follows: each of the pixels on the liquid crystal display device is divided into a main region and a subarea, the main region and the subarea can obtain different voltages through a share capacitance, the liquid crystal molecules are driven by voltage with two different turns, and the viewing angle compensation can be achieved at a large viewing angle, which improves the wide viewing angle color shift. However, the brightness of the subarea will be sacrificed by using said method, the panel brightness and the penetration rate will be reduced.

As a result, it is necessary to provide a liquid crystal pixel circuit and a liquid crystal display device to solve the problems existing in the conventional technologies, as described above.

### SUMMARY OF THE INVENTION

An object of the present disclosure is to provide a liquid crystal pixel circuit and a liquid crystal display device, which can solve the problems of the wide viewing angle color shift of a VA type liquid crystal display device and reduce the brightness of the liquid crystal display device and low penetration rate in the prior art.

To achieve the above objects, the present disclosure provides a liquid crystal pixel circuit comprising a plurality of scanning lines, a plurality of data lines, and a plurality of pixels defined by the scanning lines and the data lines, wherein each of the pixels comprises a first pixel area, a second pixel area, and a capacitor coupling module, wherein the first pixel area and the second pixel area connect to one of the scanning lines and one of the data lines; the capacitor coupling module comprises a control end, an input end, a first path end, and a second path end, wherein the control end connects to a second one of the scanning lines, the input end connects to a first pixel area of a second one of the pixels, the first path end connects to the first pixel area, and the second path end connects to the second pixel area; wherein when the scanning line is turned on, the first pixel area and the second pixel area are charged to a first potential value; and when the second one of the scanning lines is turned on, the first pixel area is charged to a second potential value and the second pixel area is charged to a third potential value, wherein the first potential value is lower than the second potential value and lower than the third potential value; wherein the capacitor coupling module comprises a first thin film transistor, a first coupling capacitor, and a second coupling capacitor, wherein a gate of the first thin film transistor connects to the control end, a source of the first thin film transistor connects to an end of the first coupling capacitor, a drain of the first thin film transistor connects to the second path end, the other end of the first coupling capacitor connects to the input end, an end of the second coupling capacitor connects to the second path end, and the other end of the second coupling capacitor connects to the first path end; and wherein the polarities of the pixels located in an identical column are the same.

In one embodiment of the present disclosure, the first pixel area comprises a second thin film transistor and a first storage component, a gate of the second thin film transistor connects to the scanning line, a source of the second thin film transistor connects to the data line, and a drain of the second thin film transistor connects to the first storage component and the first path end.

In one embodiment of the present disclosure, the first storage component comprises a first liquid crystal capacitor and a first storage capacitor. An end of the first liquid crystal capacitor connects to an end of the first storage capacitor and the drain of the second thin film transistor. The other end of the first liquid crystal capacitor connects to a common electrode, and the other end of the first storage capacitor connects to a common line.

In one embodiment of the present disclosure, the input end connects to a drain of a second thin film transistor of the second one of the pixels.

In one embodiment of the present disclosure, the second pixel area comprises a third thin film transistor and a second storage component, a gate of the third thin film transistor connects to the scanning line, a source of the third thin film transistor connects to the data line, and a drain of the third thin film transistor connects to the second storage component and the second path end.

In one embodiment of the present disclosure, the second storage component comprises a second liquid crystal capacitor and a second storage capacitor. An end of the second liquid crystal capacitor connects to an end of the second storage capacitor and the drain of the third thin film transistor. The other end of the second liquid crystal capacitor connects to a common electrode, and the other end of the second storage capacitor connects to a common line.

In one embodiment of the present disclosure, the polarities of the pixels located in adjacent columns are opposite each other.

To achieve the above objects, the present disclosure provides a liquid crystal pixel circuit comprising a plurality of scanning lines, a plurality of data lines, and a plurality of pixels defined by the scanning lines and the data lines, wherein each of the pixels comprises a first pixel area, a second pixel area, and a capacitor coupling module, wherein the first pixel area and the second pixel area connect to one of the scanning lines and one of the data lines; the capacitor coupling module comprises a control end, an input end, a first path end, and a second path end, wherein the control end connects to a second one of the scanning lines, the input end connects to a first pixel area of a second one of the pixels, the first path end connects to the first pixel area, and the second path end connects to the second pixel area; wherein when the scanning line is turned on, the first pixel area and the second pixel area are charged to a first potential value; and when the second one of the scanning lines is turned on, the first pixel area is charged to a second potential value and the second pixel area is charged to a third potential value, wherein the first potential value is lower than the second potential value and lower than the third potential value.

In one embodiment of the present disclosure, the capacitor coupling module comprises a first thin film transistor, a first coupling capacitor, and a second coupling capacitor, wherein a gate of the first thin film transistor connects to the control end, a source of the first thin film transistor connects to an end of the first coupling capacitor, a drain of the first thin film transistor connects to the second path end, the other end of the first coupling capacitor connects to the input end, an end of the second coupling capacitor connects to the second path end, and the other end of the second coupling capacitor connects to the first path end.

In one embodiment of the present disclosure, the first pixel area comprises a second thin film transistor and a first storage component, a gate of the second thin film transistor connects to the scanning line, a source of the second thin film transistor connects to the data line, and a drain of the second thin film transistor connects to the first storage component and the first path end.

In one embodiment of the present disclosure, the first storage component comprises a first liquid crystal capacitor and a first storage capacitor, an end of the first liquid crystal capacitor connects to an end of the first storage capacitor and the drain of the second thin film transistor, the other end of the first liquid crystal capacitor connects to a common electrode, and the other end of the first storage capacitor connects to a common line.

In one embodiment of the present disclosure, the input end connects to a drain of a second thin film transistor of the second one of the pixels.

In one embodiment of the present disclosure, the second pixel area comprises a third thin film transistor and a second storage component, a gate of the third thin film transistor connects to the scanning line, a source of the third thin film transistor connects to the data line, and a drain of the third thin film transistor connects to the second storage component and the second path end.

In one embodiment of the present disclosure, the second storage component comprises a second liquid crystal capacitor and a second storage capacitor, an end of the second liquid crystal capacitor connects to an end of the second storage capacitor and the drain of the third thin film transistor, the other end of the second liquid crystal capacitor connects to a common electrode, and the other end of the second storage capacitor connects to a common line.

In one embodiment of the present disclosure, the polarities of the pixels located in an identical column are the same.

In one embodiment of the present disclosure, the polarities of the pixels located in adjacent columns are opposite each other.

To achieve the above objects, the present disclosure provides a liquid crystal display device including a liquid crystal pixel circuit comprising a plurality of scanning lines, a plurality of data lines, and a plurality of pixels defined by the scanning lines and the data lines, wherein each of the pixels comprises a first pixel area, a second pixel area, and a capacitor coupling module, wherein the first pixel area and the second pixel area connect to one of the scanning lines and one of the data lines; the capacitor coupling module comprises a control end, an input end, a first path end, and a second path end, wherein the control end connects to a second one of the scanning lines, the input end connects to a first pixel area of a second one of the pixels, the first path end connects to the first pixel area, and the second path end connects to the second pixel area; wherein when the scanning line is turned on, the first pixel area and the second pixel area are charged to a first potential value; and when the second one of the scanning lines is turned on, the first pixel area is charged to a second potential value and the second pixel area is charged to a third potential value, wherein the first potential value is lower than the second potential value and lower than the third potential value.

In one embodiment of the present disclosure, the capacitor coupling module comprises a first thin film transistor, a first coupling capacitor, and a second coupling capacitor, wherein a gate of the first thin film transistor connects to the control end, a source of the first thin film transistor connects to an end of the first coupling capacitor, a drain of the first thin film transistor connects to the second path end, the other end of the first coupling capacitor connects to the input end, an end of the second coupling capacitor connects to the second path end, and the other end of the second coupling capacitor connects to the first path end.

In one embodiment of the present disclosure, the first pixel area comprises a second thin film transistor and a first storage component, wherein a gate of the second thin film transistor connects to the scanning line, a source of the second thin film transistor connects to the data line, and a drain of the second thin film transistor connects to the first storage component and the first path end.

In one embodiment of the present disclosure, the second pixel area comprises a third thin film transistor and a second storage component, wherein a gate of the third thin film transistor connects to the scanning line, a source of the third thin film transistor connects to the data line, and a drain of the third thin film transistor connects to the second storage component and the second path end.

The liquid crystal pixel circuit and the liquid crystal display device achieve a capacitive coupling effect through a capacitor coupling module, the first potential value of the first pixel area is pulled up to the second potential value, and the first potential value of the second pixel area is pulled up to the third potential value, and the capacitance value can be adjusted through the first coupling capacitor and the second coupling capacitor, so that a constant potential value is formed between the first pixel area and the second pixel area, the wide viewing angle color shift can be improved without reducing the brightness of the liquid crystal display device and the penetration rate can be increased. It can solves the problems of the wide viewing angle color shift of VA type liquid crystal display devices and reduces the brightness of the liquid crystal display device and low penetration rate in the prior art.

### DESCRIPTION OF THE DRAWINGS

To make the above present disclosure more comprehensible, preferred embodiments, along with the accompanying drawings, are described below.

Below, in conjunction with the accompanying drawings, the present disclosure will be described in detail by specific embodiments, the present disclosure will make technical and other benefits obvious.

FIG. 1 is a schematic view of a preferred embodiment of a liquid crystal pixel circuit of the present disclosure.

FIG. 2 is a schematic view of a pixel 10 and a pixel 11 in FIG. 1.

### DETAILED DESCRIPTION OF THE PREFERRED EMBODIMENTS

To further illustrate the present disclosure taken in techniques and their effects, the following in connection with preferred embodiments of the present disclosure and the accompanying drawings in detail.

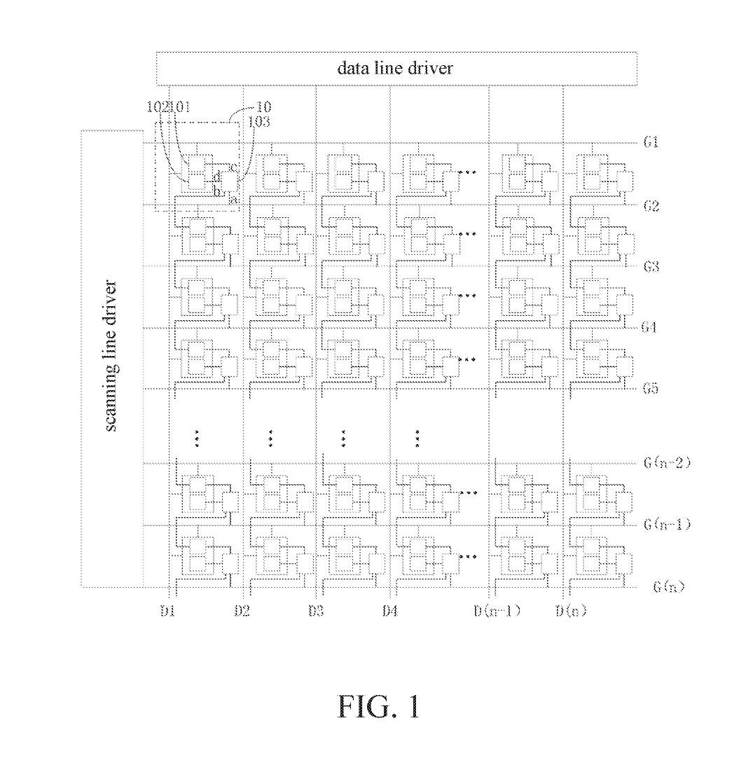

Refer to FIG. 1, which is a schematic view of a preferred embodiment of a liquid crystal pixel circuit of the present disclosure. The liquid crystal pixel circuit of the present disclosure comprises a plurality of scanning lines G(1), G(2), . . . , G(n), a plurality of data lines D(1), D(2), . . . , D(n), and a plurality of pixels 10 defined by the scanning lines G(1), G(2), . . . , G(n) and the data lines D(1), D(2), . . . , D(n), wherein each of the pixels 10 comprises a first pixel area 101, a second pixel area 102, and a capacitor coupling module 103.

Furthermore, the first pixel area 101 and the second pixel area 102 of the pixel 10 electrically connect to one of the scanning lines G(1) and one of the data lines D(1); the capacitor coupling module 103 comprises a control end a, an input end b, a first path end c, and a second path end d. The control end a connects to a second one of the scanning lines G(2), the input end b connects to a first pixel area 101 of a second one of the pixels 11, the first path end c connects to the first pixel area 101, and the second path end d connects to the second pixel area 102 of the pixel 10.

Particularly, the polarities of the pixels are located in an identical column are the same, and the polarities of the pixels are located in adjacent columns are opposite each other.

When the liquid crystal pixel circuit of the present disclosure is working, and the scanning line G(1) is turned on, the first pixel area 101 and the second pixel area 102 of the pixel 10 are charged to a first potential value; and then the second one of the scanning lines G(2) is turned on, the first pixel area 101 of the pixel 10 is charged to a second potential value and the second pixel area 102 of the pixel 10 is charged to a third potential value by capacitive coupling, wherein the first potential value is lower than the second potential value and lower than the third potential value.

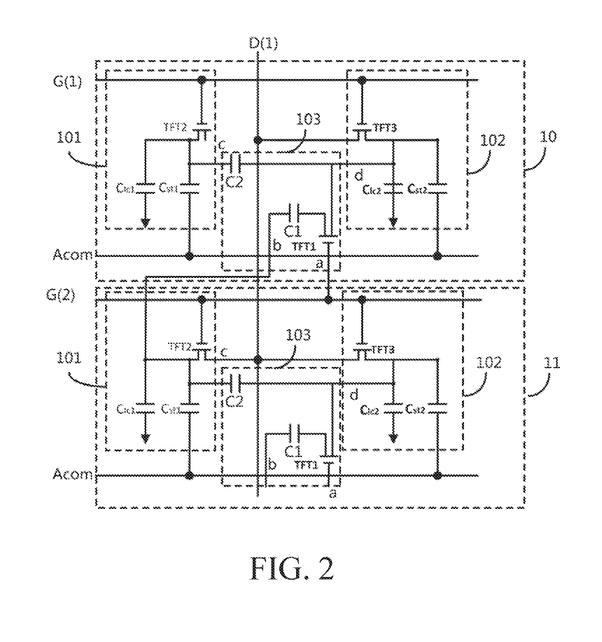

Specifically, refer to FIG. 2, which is a schematic view of a pixel 10 and a pixel 11 in FIG. 1. The capacitor coupling module 103 comprises a first thin film transistor TFT1, a first coupling capacitor C1, and a second coupling capacitor C2, wherein a gate of the first thin film transistor TFT1 connects to the control end a, a source of the first thin film transistor TFT1 connects to an end of the first coupling capacitor C1, a drain of the first thin film transistor TFT1 connects to the second path end d, the other end of the first coupling capacitor C1 connects to the input end a, an end of the second coupling capacitor C2 connects to the second path end d, and the other end of the second coupling capacitor C2 connects to the first path end c.

The first pixel area 101 comprises a second thin film transistor TFT2 and a first storage component; a gate of the second thin film transistor TFT2 connects to the scanning line G(1), a source of the second thin film transistor TFT2 connects to the data line D(1), and a drain of the second thin film transistor TFT2 connects to the first storage component and the first path end c; wherein the first storage component comprises a first liquid crystal capacitor Clc1 and a first storage capacitor Cst1; an end of the first liquid crystal capacitor Clc1 connects to an end of the first storage capacitor Cst1 and the drain of the second thin film transistor TFT2; the other end of the first liquid crystal capacitor Clc1 connects to a common electrode, and the other end of the first storage capacitor connects to a common line Acom. Moreover, the input end a connects to a drain of a second thin film transistor TFT2 of the second one of the pixels 11.

The second pixel area 102 comprises a third thin film transistor TFT3 and a second storage component; a gate of the third thin film transistor TFT3 connects to the scanning line G(1); a source of the third thin film transistor TFT3 connects to the data line D(1), and a drain of the third thin film transistor TFT3 connects to the second storage component and the second path end d; wherein the second storage component comprises a second liquid crystal capacitor Clc2 and a second storage capacitor Cst2; an end of the second liquid crystal capacitor Clc2 connects to an end of the second storage capacitor Cst2 and the drain of the third thin film transistor TFT3; the other end of the second liquid crystal capacitor Clc2 connects to a common electrode, and the other end of the second storage capacitor Cst2 connects to a common line Acom.

The working principle of preferred embodiment of the present disclosure is as follows:

when the scanning line G(1) outputs a high level scan signal, the second thin film transistor TFT2 and the third thin film transistor TFT3 are turned on, and the data line D(1) outputs a data signal to charge the first pixel area 101 and the second pixel area 102. Specifically, the data signal charges the first liquid crystal capacitor Clc1 and the first storage capacitor Cst1 through the second thin film transistor TFT2, so that the first pixel area 101 is charged to a first potential value. Similarly, the data signal charges the second liquid crystal capacitor Clc2 and the second storage capacitor Cst2 through the third thin film transistor TFT3, so that the second pixel area 102 is charged to the first potential value.

The scanning line G(1) outputs a low level scan signal, and the second thin film transistor TFT2 and the third thin film transistor TFT3 are turned off, and then a second one of the scanning lines G(2) outputs a high level scan signal, so that the third thin film transistor TFT3, a second thin film transistor TFT2 of a second one of the pixels 11 and a third thin film transistor TFT3 of the second one of the pixels are turned on, the data line D(1) outputs a data signal to charge a first pixel area and a second pixel area of the second one of the pixels 11. a potential value of the first pixel area 101 of the second one of the pixels 11 is a polarity voltage of previous frame picture, and the data line D(1) charges the potential value of the first pixel area from a potential value of last frame to a potential value of current frame, so that the first coupling capacitor and the second coupling capacitor achieve a capacitive coupling effect. The first potential value of the first pixel area 101 of the pixel 10 is pulled up to a second potential value, and the first potential value of the second pixel area 102 of the pixel 10 is pulled up to a third potential value, thus the brightness of the liquid crystal display device and a penetration rate can be increased.

Furthermore, the second potential value of the first pixel area 101 and the third potential value of the second pixel area 102 can obtain a different potential value by adjusting the capacitance value of the first coupling capacitor and the second coupling capacitor, so that the liquid crystal of the first pixel area 101 and the second pixel area 102 have different deflections, thus the problem of a wide viewing angle color shift can be improved, and the display quality of the liquid crystal display device can be improved.

The liquid crystal pixel circuit of the present disclosure achieves a capacitive coupling effect through a capacitor coupling module, the first potential value of the first pixel area is pulled up to the second potential value, and the first potential value of the second pixel area is pulled up to the third potential value, and the capacitance value can be adjusted through the first coupling capacitor and the second coupling capacitor, so that a constant potential value is formed between the first pixel area and the second pixel area, the wide viewing angle color shift can be improved without reducing the brightness of the liquid crystal display device and the penetration rate can be increased. It solves the problems of the wide viewing angle color shift of a VA type liquid crystal display device and reduces the brightness of the liquid crystal display device and low penetration rate in the prior art.

A liquid crystal display device of the present disclosure is also provided, the liquid crystal display device comprises the liquid crystal pixel circuit of said preferred embodiment, and the liquid crystal pixel circuit in the foregoing embodiments have been discussed in more detail, and will not be repeated here.

The liquid crystal display device achieves a capacitive coupling effect through a capacitor coupling module, the first potential value of the first pixel area is pulled up to the second potential value, and the first potential value of the second pixel area is pulled up to the third potential value, and the capacitance value can be adjusted through the first coupling capacitor and the second coupling capacitor, so that a constant potential value is formed between the first pixel area and the second pixel area, the wide viewing angle color shift can be improved without reducing the brightness of the liquid crystal display device and the penetration rate can be increased. It solves the problems of the wide viewing angle color shift of a VA type liquid crystal display device and reduces the brightness of the liquid crystal display device and low penetration rate in the prior art.

In summary, although the present invention has been described in preferred embodiments above, the preferred embodiments described above are not intended to limit the invention, ordinary testers in the art, without departing from the spirit and scope of the present invention, can make all kinds of modifications and variations, so the scope of protection scope of the invention is defined by the claims.

What is claimed is:

1. A liquid crystal pixel circuit, comprising: a plurality of scanning lines, a plurality of data lines, and a plurality of pixels defined by the scanning lines and the data lines, wherein each of the pixels comprises:
a first pixel area, a second pixel area, and a capacitor coupling module;
wherein the first pixel area and the second pixel area connect to one of the scanning lines and one of the data lines; the capacitor coupling module comprises a control end, an input end, a first path end, and a second path end, wherein the control end connects to a second one of the scanning lines, the input end connects to a first pixel area of a second one of the pixels, the first path end connects to the first pixel area, and the second path end connects to the second pixel area;
wherein when the scanning line is turned on, the first pixel area and the second pixel area are charged to a first potential value; and when the second one of the scanning lines is turned on, the first pixel area is charged to a second potential value and the second pixel area is charged to a third potential value, wherein the first potential value is lower than the second potential value and lower than the third potential value;
wherein the capacitor coupling module comprises a first thin film transistor, a first coupling capacitor, and a second coupling capacitor, wherein a gate of the first thin film transistor connects to the control end, a source of the first thin film transistor connects to an end of the first coupling capacitor, a drain of the first thin film transistor connects to the second path end, the other end of the first coupling capacitor connects to the input end, an end of the second coupling capacitor connects to the second path end, and the other end of the second coupling capacitor connects to the first path end; and
wherein the polarities of the pixels located at an identical column are the same.

2. The liquid crystal pixel circuit according to claim 1, wherein the first pixel area comprises a second thin film transistor and a first storage component, a gate of the second thin film transistor connects to the scanning line, a source of the second thin film transistor connects to the data line, and a drain of the second thin film transistor connects to the first storage component and the first path end.

3. The liquid crystal pixel circuit according to claim 2, wherein the first storage component comprises a first liquid crystal capacitor and a first storage capacitor, an end of the first liquid crystal capacitor connects to an end of the first storage capacitor and the drain of the second thin film transistor, the other end of the first liquid crystal capacitor connects to a common electrode, and the other end of the first storage capacitor connects to a common line.

4. The liquid crystal pixel circuit according to claim 3, wherein the input end connects to a drain of a second thin film transistor of the second one of the pixels.

5. The liquid crystal pixel circuit according to claim 1, wherein the second pixel area comprises a third thin film transistor and a second storage component, a gate of the third thin film transistor connects to the scanning line, a source of the third thin film transistor connects to the data line, and a drain of the third thin film transistor connects to the second storage component and the second path end.

6. The liquid crystal pixel circuit according to claim 5, wherein the second storage component comprises a second liquid crystal capacitor and a second storage capacitor, an end of the second liquid crystal capacitor connects to an end of the second storage capacitor and the drain of the third thin film transistor, the other end of the second liquid crystal capacitor connects to a common electrode, and the other end of the second storage capacitor connects to a common line.

7. The liquid crystal pixel circuit according to claim 1, wherein the polarities of the pixels located in adjacent columns are opposite each other.

8. A liquid crystal pixel circuit, comprising a plurality of scanning lines, a plurality of data lines, and a plurality of pixels defined by the scanning lines and the data lines, wherein each of the pixels comprises:
a first pixel area, a second pixel area, and a capacitor coupling module;
wherein the first pixel area and the second pixel area connect to one of the scanning lines and one of the data lines; the capacitor coupling module comprises a control end, an input end, a first path end, and a second path end, wherein the control end connects to a second one of the scanning lines, the input end connects to a first pixel area of a second one of the pixels, the first path end connects to the first pixel area, and the second path end connects to the second pixel area;
wherein when the scanning line is turned on, the first pixel area and the second pixel area are charged to a first potential value; and when the second one of the scanning lines is turned on, the first pixel area is charged to a second potential value and the second pixel area is charged to a third potential value, wherein the first potential value is lower than the second potential value and lower than the third potential value.

9. The liquid crystal pixel circuit according to claim 8, wherein the capacitor coupling module comprises a first thin film transistor, a first coupling capacitor, and a second coupling capacitor, wherein a gate of the first thin film transistor connects to the control end, a source of the first thin film transistor connects to an end of the first coupling capacitor, a drain of the first thin film transistor connects to the second path end, the other end of the first coupling capacitor connects to the input end, an end of the second coupling capacitor connects to the second path end, and the other end of the second coupling capacitor connects to the first path end.

10. The liquid crystal pixel circuit according to claim 8, wherein the first pixel area comprises a second thin film transistor and a first storage component, a gate of the second thin film transistor connects to the scanning line, a source of the second thin film transistor connects to the data line, and a drain of the second thin film transistor connects to the first storage component and the first path end.

11. The liquid crystal pixel circuit according to claim 10, wherein the first storage component comprises a first liquid crystal capacitor and a first storage capacitor, an end of the first liquid crystal capacitor connects to an end of the first storage capacitor and the drain of the second thin film transistor, the other end of the first liquid crystal capacitor connects to a common electrode, and the other end of the first storage capacitor connects to a common line.

12. The liquid crystal pixel circuit according to claim 11, wherein the input end connects to a drain of a second thin film transistor of the second one of the pixels.

13. The liquid crystal pixel circuit according to claim 8, wherein the second pixel area comprises a third thin film transistor and a second storage component, a gate of the third thin film transistor connects to the scanning line, a source of the third thin film transistor connects to the data line, and a drain of the third thin film transistor connects to the second storage component and the second path end.

14. The liquid crystal pixel circuit according to claim 13, wherein the second storage component comprises a second liquid crystal capacitor and a second storage capacitor, an end of the second liquid crystal capacitor connects to an end of the second storage capacitor and the drain of the third thin film transistor, the other end of the second liquid crystal capacitor connects to a common electrode, and the other end of the second storage capacitor connects to a common line.

15. The liquid crystal pixel circuit according to claim 8, wherein the polarities of the pixels located in an identical column are the same.

16. The liquid crystal pixel circuit according to claim 8, wherein the polarities of the pixels located in adjacent columns are opposite each other.

17. A liquid crystal display device, including a liquid crystal pixel circuit comprising: a plurality of scanning lines, a plurality of data lines, and a plurality of pixels defined by the scanning lines and the data lines, wherein each of the pixels comprises:
a first pixel area, a second pixel area, and a capacitor coupling module;
wherein the first pixel area and the second pixel area connect to one of the scanning lines and one of the data lines; the capacitor coupling module comprises a control end, an input end, a first path end, and a second path end, wherein the control end connects to a second one of the scanning lines, the input end connects to a first pixel area of a second one of the pixels, the first path end connects to the first pixel area, and the second path end connects to the second pixel area;
wherein when the scanning line is turned on, the first pixel area and the second pixel area are charged to a first potential value; and when the second one of the scanning lines is turned on, the first pixel area is charged to a second potential value and the second pixel area is charged to a third potential value, wherein the first potential value is lower than the second potential value and lower than the third potential value.

18. The liquid crystal display device according to claim 17, wherein the capacitor coupling module comprises a first thin film transistor, a first coupling capacitor, and a second coupling capacitor, wherein a gate of the first thin film transistor connects to the control end, a source of the first thin film transistor connects to an end of the first coupling capacitor, a drain of the first thin film transistor connects to the second path end, the other end of the first coupling capacitor connects to the input end, an end of the second coupling capacitor connects to the second path end, and the other end of the second coupling capacitor connects to the first path end.

19. The liquid crystal display device according to claim 17, wherein the first pixel area comprises a second thin film transistor and a first storage component, wherein a gate of the second thin film transistor connects to the scanning line, a source of the second thin film transistor connects to the data line, and a drain of the second thin film transistor connects to the first storage component and the first path end.

20. The liquid crystal display device according to claim 17, wherein the second pixel area comprises a third thin film transistor and a second storage component, wherein a gate of the third thin film transistor connects to the scanning line, a source of the third thin film transistor connects to the data line, and a drain of the third thin film transistor connects to the second storage component and the second path end.
